(19) United States
(12) Patent Application Publication
(10) Pub. No.: US 2005/0130491 A1
(43) Pub. Date: Jun. 16, 2005

(54) Automobile compact fuse holder

(76) Inventor: Norberto Julio Chirkes, Buenos Aires (AR)

Correspondence Address: PEARNE & GORDON LLP, 1801 EAST 9TH STREET, SUITE 1200, CLEVELAND, OH, 44114-3108, US

(21) Appl. No.: 10/734,519

(22) Filed: Dec. 12, 2003

(51) Int. Cl. H01R 3/00

(52) U.S. Cl. 439/488

(57) ABSTRACT

An automobile compact fuse holder comprising: a small plate including at least two protective circuits, each one of them comprising a resettable fuse consisting in a positive temperature coefficient element (PTC) connected to two terminals, being each pair of terminals of each protective device connected to a light signal generating element, wherein each protective circuit has two input and output connectors, and said each pair of terminals are additionally connected to a sole second light signal disposed on the small plate. Additionally, said each pair of terminals are connected to an audible signal generating circuit. The positive temperature element (PTC) is one of a polymeric, ceramic, thermistor, bimetallic type. The light signal generating element is selected from an electric bulb or lamp, a diode and a biode, and the input and output connectors of each protective circuit, may be all male, all female or male-female.

### FIELD OF THE INVENTION

The present invention pertains to the protective circuit field, preferably to the field of resettable fuses. More specifically, the present invention refers to an automobile resettable compact fuse holder.

### BACKGROUND OF THE INVENTION

Automobile electric circuits necessarily include protective circuits disposed in a fuse holder, giving protection to several sections of the installation if eventual short-circuits occur therein.

Generally, protective circuits comprise a device having two connection plane terminals and a low resistance conductor or fuse designed in such a way that maintains the circuit continuity when current does not exceed a determined value according to the elements connected to such circuits.

If an overcurrent occurs due to a short-circuit in any circuit element, the conductor or fuse blows out and cuts out the circuit, protecting in such way the elements which remained undamaged from the overcurrent.

Then user must identify the damaged fuse and circuit, repair the fault and finally replace the protective device which cut out current and gave protection to remaining circuit so as to restore current.

U.S. Pat. No. 5,004,995 refers to an automobile fuse comprising a body with two rectangular housings laterally disposed including two conductor plates and a third rectangular housing including a fuse and a light bulb, such bulb switches on when the fuse cuts out due to overcurrent, enabling the user to identify the damaged fuse in the fuse holder. However, such devices are much more expensive than commonly used devices with no light indication and among these installations a fuse holder enabling recharge of fuses in an independent way, is typically used.

U.S. Pat. No. 5,598,138 refers to a fuse with fault indicator having a light emitting electric device, located on the fuse for its visual display. Such device is activated when fuse blows out due to overcurrent and it includes connectors at both ends electrically connected to fuse connection blades. It can be used as light emitting electric device a small incandescent bulb or light emitting diode (LED). As it occurs in prior embodiment, costs of such fuses are high in comparison with commonly used devices without indicators and the fuse holder is traditionally provided in an automobile.

U.S. Pat. No. 5,663,861 refers to a protective device for a resettable automobile electric circuit including a pair of terminals to be electrically connected to an electric circuit to be protected, each pair of terminals having an extension to transmit current and between them it is located a current-limiting element of initial low resistance. Such current-limiting element comprises current feeder terminals, conductive and flexible, wherein the inner terminal portions of same are electrically connected to the terminal extensions of the device. Preferably, the device includes a PTC type current-limiting element between flexible external terminal portions of current feeder terminals, which upon an overcurrent occurrence reaches a given trigger level which surprisingly and substantially expands same to flection external terminal portions. Such device was thought to be used in common fuse holders of fuse substitution type.

U.S. Pat. No. 5,682,130 describes a protective device comprising a first and second female terminal insulated one from the other and each one connected to a conductive clamp thus obtaining a compact configuration, half of it is encapsulated in a substantially prismatic housing. The electrical contact between both clamps closing the circuit and enabling current flow through, is achieved by means of a positive temperature coefficient element (PTC), which interrupts circuit continuity. Clamps are preferably spring type.

U.S. Pat. No. 5,945,903 refers to protective device as the one described in prior U.S. Pat. No. 5,663,861, but with a pair of extensions, or female terminals, spaced in between which conduct current to the location where blades of the device male terminals insert.

Protective devices known in the art, provide protection in case of a protective circuit breakdown caused by an overcurrent, allowing in some cases as well, a light visual alarm to identify the protective device which fuse is cut out and thus identify also the damaged circuit.

If fuse is resettable, same may be reused, but it is not known in the art devices of this type with visual and/or audible alarm.

Modern automobile electrical installations has increased the need of reliable fuses and larger quantities of them so as to protect each existing circuit in the automobile. Such devices individually connected, render this automobile electric installations an extra complexity characteristic, thus increasing considerably manufacturing costs.

In order to simplify this increasing complexity in automobile electric installations, and to achieve cheaper costs of assembly and installation, as well as those of maintenance, present embodiment describes a resettable compact fuse holder for automobile electric circuits.

Above fuse holder comprises a light signal in each fuse to indicate which is the damaged circuit, enabling as well its reuse, and a second additional light signal located in the small plate or in the vehicle dashboard, to indicate that a fault is being detected.

Preferably, when including a sound signal it enables an audible detection of an electric fault in any circuit, assuring a fast and early fault detection. This audible signal generating circuit may also be installed in the small plate or in the automobile dashboard.

### SUMMARY OF THE INVENTION

Present invention describes an automobile compact fuse holder which comprises: a small plate with at least two protective circuits, each one of them including a resettable fuse consisting of a positive temperature coefficient element (PTC) connected to two terminals, being each pair of terminals of each protective device connected to a light signal generating element, wherein each protective circuit presents two connectors, an input connector and an output one, and said each pair of terminals are additional connected to a sole general second light signal. Additionally, said each pair of terminals are connected to an audible signal generating circuit.

The positive temperature element (PTC) is one of a polymeric, ceramic, thermistor and bimetallic type.

As light signal generating elements, the following can be used, electric bulbs or lamps, diodes and biodes, and input and output connectors of each protective circuit, all of them may be male, all female, or a male input and female output, or viceversa.

### BRIEF DESCRIPTION OF DRAWINGS

FIG. 1 shows the electric circuit in a preferred embodiment of the compact fuse holder according to the present invention, illustrated to protect three circuits, which includes one circuit providing a light signal in each fuse, and a general second light signal incorporated into the small plate.

FIG. 2 shows the electric circuit in another preferred embodiment of the compact fuse holder according to the present invention, illustrated to protect three circuits, which includes one circuit providing a light signal in each fuse and a general second light signal incorporated into the small plate, which further comprises an incorporated fault audible signal.

FIG. 3 shows the electric circuit in another preferred embodiment of the compact fuse holder according to the present invention, illustrated to protect three circuits, which includes one circuit providing a light signal in each fuse and a general second light signal, which further comprises a fault audible signal, wherein the second light signal and the audible signal generator are designed to be installed in the board.

FIG. 4 shows a preferred embodiment of the compact fuse holder according to the present invention, illustrated to protect four circuits, which includes a light signal in each fuse, a general second light signal and an audible signal generator on the small plate. Such small plate having male connectors at both sides.

### DETAILED DESCRIPTION OF THE INVENTION

A preferred embodiment to carry into practice the present invention consists in a protective device for automobile circuits which comprises a resettable compact fuse holder including at least two protective circuits, each one having a light signal generating circuit, and an additional generating circuit of a sole general second light signal.

Said compact fuse holder comprises a small plate wherein at least two or more protective circuits are installed, each of them including a fuse connected in parallel with a light signal generating circuit, wherein each protective circuit presents two connectors, an input connector and an output connector, and said each pair of terminals are additionally connected to a sole general second light signal. Additionally, said each pair of terminals are connected to a sole audible signal generating circuit being series connected with each light signal generating circuit, all of which may be included in the small plate to form a sole body, and each one of them having its respective input and output connecting terminals exposed on the body of said small plate for its connection with the different circuits to be protected in the automobile.

Further, generating circuits of additional sole general second light signal and additional generating circuit of an audible signal may be designed to be installed in the automobile dashboard.

Each protective device comprises therefore, a light signal generating element which function is to detect the affected or damaged circuit and an additional generating circuit of a sole second light signal in the small plate or in the automobile dashboard in order to detect the existing fault.

Additionally, the small plate of the compact fuse holder may comprise an auxiliary circuit which generates an audible signal, such circuit is activated when any of the resettable fuses operates, same is designed to be installed in the small plate or automobile dashboard.

Fuses of each protective device consist in a positive temperature coefficient element (PTC), which interrupts current flow when reaching a certain temperature and reinstates the connection when it cools down after the circuit damaged element at issue is repaired.

As PTC materials, it can be used any of those known in the art, such as polymeric, ceramic, thermistor and bimetallic ones. In all cases these materials may have tolerances and breakdown capacitance which may rise according to the circuit to be protected. Also in all cases, ambient temperature resistance is minimum, but when a short-circuit occurs and temperature rises caused by an increase in current flow, a breakdown is allowed in current flow of PTC element. When such PTC element cools down, current is reinstated and such element works as a resettable fuse and there is no need to replace it for a new one.

Preferably, the operative range of current cutoff of PTC fuses used in this invention is from 1 to 40 amperes. The value used for each one of them depends on the circuit to be protected and it shall be chosen according to electric circuit design of automobile. Generally, maximum voltages of 30 volts are estimated and also maximum current flows of 40 amperes PTC element operating as a fuse, is connected in parallel with generating element of a visual light signal having high resistance and therefore, it only displays such light signal when PTC element of minor resistance operates the circuit when its temperature increases because of a short-circuit.

In the present invention, elements generating a light visual signal such as electric bulbs or lamps, diodes or biodes, can be used. In the case of a bulb or diode, the light signal is the same, independently from electric current direction, unless for example two diodes are connected, each one to a terminal, enabling two polarities. A single biode element, on the other part, may detect current direction because the light signal changes its color when current flows to one or another direction.

All protective circuits connected in the small plate are additionally electrically connected to a second light signal generating circuit. Thus, when a short-circuit occurs in any of the circuits tied to the small plate protective circuits, such generating circuit of a second general light signal, in series connection with all generating elements of primary light signals, is activated transmitting a light signal so that the vehicle driver perceives a fault existence in any of the electric circuits.

Above mentioned general light signal may be an intermittent one and with any desirable intensity.

Additionally, all protective circuits connected to the small plate are electrically connected to a an audible signal generating circuit. Therefore, when a short-circuit occurs in any circuit tied to the small plate protective circuits, such sound signal generating circuit in series connection with all light signal generating elements, is activated producing an audible sound so that the vehicle driver perceives a fault existence in one of the electric circuits.

Audible signal generating circuits may be any of those already known in the art, able to generate an audible signal like for example the buzzer type. The siren power of these audible signal generating circuits preferred for its use in the compact fuse holder of the present invention, oscillates between 5 and 10 watts.

Both, the general second light signal generating circuit and the audible signal generating circuit, may be installed in the small plate of the present invention fuse holder, or else it may be arranged for its installation in the automobile dashboard. The purpose of which is to call the attention of the driver so that he/she perceives the fault occurrence as soon as possible, in a comfortable manner, according to circuit design of vehicle.

The current requirements for the operation of the whole protective circuit are minimum, not more than 0,3 amperes as a most unfavorable case, and may be covered by any of the vehicle batteries now in market.

Finally, once the small plate has been already assembled with all its electronic components electrically connected to each other, such small plate may be placed in a suitable mold to which a polymeric material is injected, molded or slipped in, covering the whole assembly, leaving empty spaces so that the different light signals may be seen and the audible signal detected. Thus, the small plate is integrated in a sole assembly or block, including different types of connectors to connect the small plate with the different automobile circuits to be protected.

Polymeric materials such as the already known in the art, may be used such as polyester, polyurethane, epoxy resins etc. both homo and heteropolymeric ones.

Above connectors may all be male type, all female or else input connectors male and output connectors female, or viceversa, as it best fits to facilitate the connection of the small plate with circuits to be protected in the automotive vehicle electric installation.

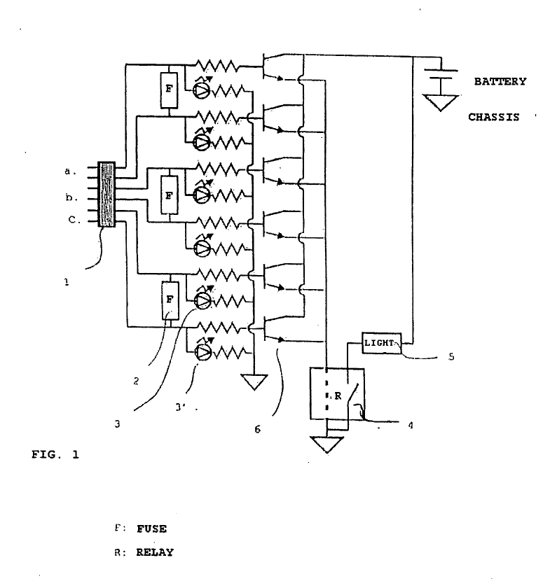

FIG. 1 shows a circuit in a preferred embodiment which puts into practice the compact fuse holder of the present invention, illustrated to protect only three circuits (a, b, c), but which may be designed for any number of circuits necessary according to the vehicle electric installation The circuit comprises male-female connectors (1) for the three circuits (a, b, c) connecting each one of the protective circuits (2) which comprise resettable fuses of PTC type. When a fault occurs in any of the vehicle circuits, PTC fuse cuts out current when its temperature increases, enabling the light signal generating circuit (3, 3′), in this case intermittent LED type diodes located in each terminal of the protective circuit, to generate a light signal according to the polarity generated after the occurrence of the fault and to further activate, by means of a relay (4) an external fault monitor light placed on the small plate of the compact fuse holder or in the vehicle dashboard. The two LEDS may be replaced by a single light signal generating element or biode, or simply by a lamp without any information about polarity.

The connection of such monitor light is done by means of a circuit in parallel with circuit (3, 3′) by means of a transistor (6) of a NPN transistor type of low power, as those commonly used in audio circuits, such as BC548 or equivalents.

Series resistance with (3, 3′) and with (6) have the capacity to dissipate at least 0,25 watts approximately, having a value of between 820 and 1.500 ohm and between 330 and 1.000 ohm each one respectively; more preferably between 900 and 1.100 ohm and between 400 and 600 ohm, respectively; even more preferably between 950 and 1.050 ohm and between 450 and 490 ohm, also respectively.

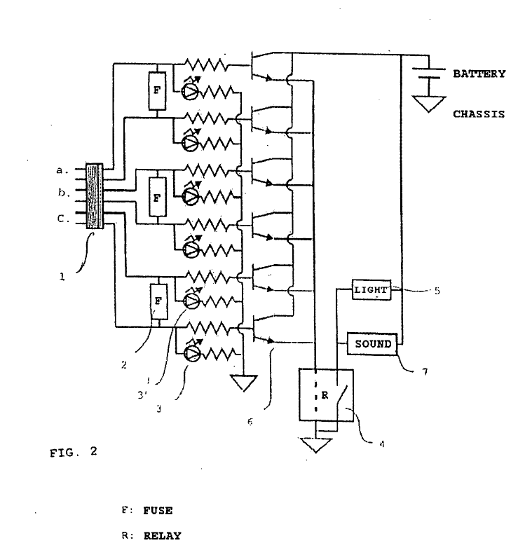

FIG. 2 shows the electric circuit in another preferred embodiment of the compact fuse holder according to the present invention, illustrated to protect three circuits (a, b, c), such compact fuse holder includes a circuit (3, 3′) to provide a light signal for each fuse, of intermittent LED diodes type, and which comprises as well, a circuit to provide a general fault light signal (5) and a fault audible one (7) incorporated in the small plate of the fuse holder.

The preferred values of components are equivalent to those described in FIG. 1, taking into account that the audible signal generating circuit may be any already known in prior art which may generate a sound alarm, as for example the buzzer type, having a preferred audible signal siren power between 5 and 10 watts.

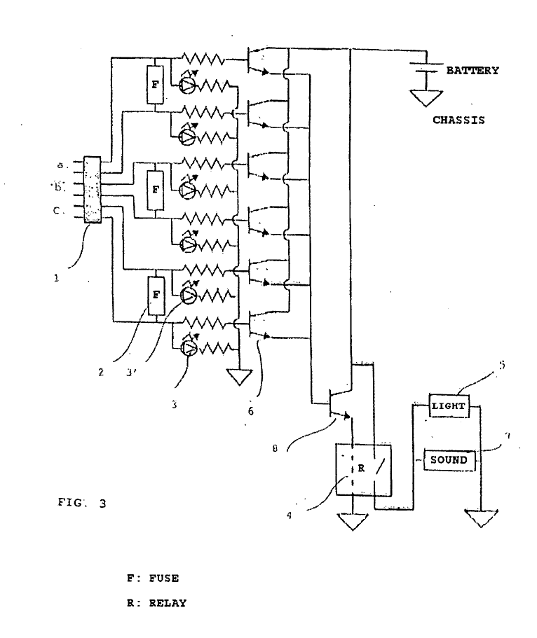

FIG. 3 shows the electric circuit in another preferred embodiment of the compact fuse holder according to this invention, illustrated to protect three circuits (a, b, c), such fuse holder includes circuits (3, 3′) to provide a light signal with intermittent LEDS indicating the polarity for each fuse (2) and which further comprises a circuit to provide a fault light signal (5) and fault audible signal (7) for the vehicle control board.

In above embodiment of circuit for a compact fuse holder, an optional connection is illustrated wherein the general fault monitor light (5) and the audible signal generating circuit (7) are disposed outside the small plate of the fuse holder. Thus, above monitor light (5) and audible signal generating circuit (7) may be connected to the automotive vehicle dashboard, while the small plate may be indistinctly disposed within the vehicle housing or outside the same.

Preferred values of components are equivalent to those described in FIG. 1, taking into account that the fault external monitor light (5) and the audible signal generating circuit (7) are connected to the relay (4) which is connected to transistors (6) of a low power NPN type of the small plate by means of a transistor (8) of medium power NPN type, such as those used in audio applications, which may be a BD131 or equivalent as it is shown in Figure.

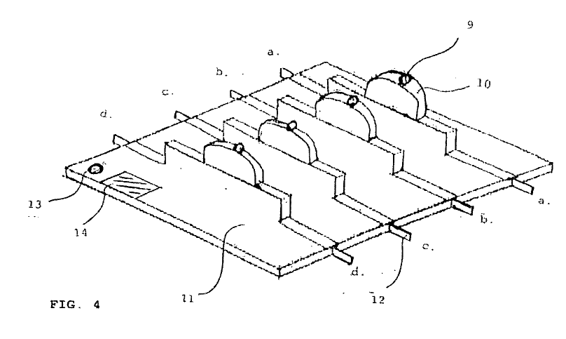

FIG. 4 shows a preferred embodiment of the compact fuse holder according to the present invention, illustrated to protect four circuits (a, b, c, d), such fuse holder includes a light signal (9) for each fuse. It can be seen the different fuses (10) disposed on the small plate (11) in a parallel way, each one of them having its corresponding light signal (9), as well as the input and output male connectors (12), the general light signal (13) and the horn (14) of the sound generator or buzzer.

Any combination of elements already known in the art as those herein stated or described to achieve the same object of the present invention, shall be considered within the scope of this invention and, having already described preferred embodiments and the way in which the object of this invention may be carried into practice, I wish to claim the following.

1. A compact fuse holder for an automobile which comprises: a small plate including at least two protective circuits, each one of them comprises a resettable fuse consisting in a positive temperature coefficient element (PTC) connected to two terminals, being each pair of terminals of each of the protective devices connected to a light signal generating circuit, wherein each protective circuit presents two input and output connectors, and such each pair of terminals are additionally connected to a sole second light signal.

2. The compact fuse holder in accordance with claim 1, wherein such sole second light signal is located on the small plate.

3. The compact fuse holder in accordance with claim 1, wherein such sole second light signal is installed in the vehicle dashboard.

4. The compact fuse holder in accordance with claim 2, wherein additionally such each pair of terminals are connected to an audible signal generating circuit.

5. The compact fuse holder in accordance with claim 4, wherein such. audible signal generating circuit is a buzzer.

6. The compact fuse holder in accordance with any of the claims 4 or 5, wherein such audible signal generating circuit is located on the small plate.

7. The compact fuse holder in accordance with any of the claims 4 o 5, wherein such audible signal generating circuit is installed in the vehicle dashboard.

8. The compact fuse holder in accordance with claim 1, wherein the positive temperature element (PTC) is selected among one of a polymeric, ceramic, thermistor bimetallic type.

9. The compact fuse holder in accordance with claim 1, wherein the light signal generating element is selected between an electric bulb or lamp, a diode and a biode.

10. The compact fuse holder in accordance with claim 1, wherein the input and output connectors of each protective circuit are all male, all female, or male for the input and female for the output, or viceversa.
